(19) United States
(12) Patent Application Publication
(10) Pub. No.: US 2018/0350015 A1
(43) Pub. Date: Dec. 6, 2018

(54) E-LEARNING ENGAGEMENT SCORING

(71) Applicant: LinkedIn Corporation, Sunnyvale, CA (US)

(72) Inventors: Nathan Gordon, San Francisco, CA (US); Coleman Patrick King, III, Brooklyn, NY (US); Zhaoying Han, Mountain View, CA (US)

(21) Appl. No.: 15/613,691

(22) Filed: Jun. 5, 2017

(51) Int. Cl. G06Q 50/20; G06Q 30/02; G06N 99/00

(52) U.S. Cl. CPC G06Q 50/20; G06N 99/005; G06Q 30/0201

(57) ABSTRACT

In some embodiments, the disclosed subject matter involves metrics collection and analysis to quantify customer engagement with an objective score to measure customer engagement in an c-learning system. Embodiments may generate a single engagement score as a one-number summary of e-learning product usage by a customer The one number summary may be generated as a normalized weighted sum of individual metrics scores. An embodiment may use activation, login, view, or other usage rates as part of the weighted sum. The weighted sum for a product customer may be normalized as compared to other customers for the same or similar product, where the other customer may be similar in size and/or industry to the target customer. An embodiment may use metrics relating to skills attained and applied as a skill assessment score. Other embodiments are described and claimed.

### TECHNICAL FIELD

An embodiment of the present subject matter relates generally to electronic learning (e-learning), and, more specifically, to metrics collection and analysis to quantify customer engagement with an objective score to measure customer engagement in an e-learning system.

### BACKGROUND

Distance learning and electronic learning (e-learning) have been used in the last several years to advance the academic knowledge and professional skill levels of both employees and students, for instance in primary and adult education, and in corporate environments. E-learning may include simple viewing of academic materials, interactive learning modules, webcasts, etc. Some interactive modules require a user to affirmatively acknowledge their presence at periodic intervals, for instance by clicking on a link, as proof of attendance. Some e-learning systems require a user to complete a quiz or test at the end of a module to certify understanding of the material, and/or as a pre-requisite before passing to the next module. There are many methods for teaching or providing the academic or practical materials over a private or public network or by downloading a teaching module directly to a local device.

However, there are no standardized ways of reporting e-learning usage in the industry. A corporation may spend many thousands of dollars to provide e-learning opportunities for its employees. Measuring the customer engagement with their chosen e-learning platform may be difficult. E-learning providers have historically reported individual metrics on an ongoing basis, but the current literature is lacking on standardization, benchmarking and especially globally useful scoring methods.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a flow diagram illustrating a method for engagement scoring, according to an embodiment;

FIG. 2 is a flow diagram illustrating a weighting method, according to an embodiment;

FIG. 3A illustrates a graph showing a rolling three month average of engagement scores, according to an embodiment;

FIG. 3B illustrates a graphic showing trends in scoring metrics for the engagement scores in FIG. 3A, according to an embodiment;

FIG. 4A shows an engagement score over time for a first company, according to an embodiment;

FIG. 4B shows an engagement score over time for a second company, according to an embodiment;

FIG. 5A shows an activation rate over time for a first company, according to an embodiment;

FIG. 5B shows an activation rate over time for a second company, according to an embodiment;

FIG. 6A shows users logging in metric over time for a first company, according to an embodiment;

FIG. 6B shows users logging in metric over time for a second company, according to an embodiment;

FIG. 7A shows logins per user metric over time for a first company, according to an embodiment;

FIG. 7B shows logins per user metric over time for a second company, according to an embodiment;

FIG. 8A shows minutes of content viewed per user metric over time for a first company, according to an embodiment;

FIG. 8B shows minutes of content viewed per user metric over time for a second company, according to an embodiment;

FIG. 9A shows monthly video views per user metric for a first company, according to an embodiment;

FIG. 9B shows monthly video views per user metric for a second company, according to an embodiment;

FIG. 10A shows views per login metric for a first company, according to an embodiment;

FIG. 10B shows views per login metric for a first company, according to an embodiment;

FIG. 11 is a flow diagram illustrating a method for scoring skills gained, according to an embodiment;

FIG. 12 is a system block diagram illustrating metrics score calculation, according to an embodiment;

FIG. 13 is a system block diagram illustrating metrics collection and score generating system with feedback loop, according to an embodiment; and

FIG. 14 is a block diagram illustrating an example of a machine upon which one or more embodiments may be implemented.

### DETAILED DESCRIPTION

In the following description, for purposes of explanation, various details are set forth in order to provide a thorough understanding of some example embodiments. It will be apparent, however, to one skilled in the art that the present subject matter may be practiced without these specific details, or with slight alterations.

An embodiment of the present subject matter is a system and method relating to generating a single engagement score as a one-number summary of e-learning product usage by a customer. Embodiments may provide teams internal to the e-learning provider, as well as their clients, a quick and easy way to determine how much their e-learning product is being used by end users, and to benchmark their usage versus similar accounts or their competition, over time.

Reference in the specification to “one embodiment” or “an embodiment” means that a particular feature, structure or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment, or to different or mutually exclusive embodiments. Features of various embodiments may be combined in other embodiments..

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

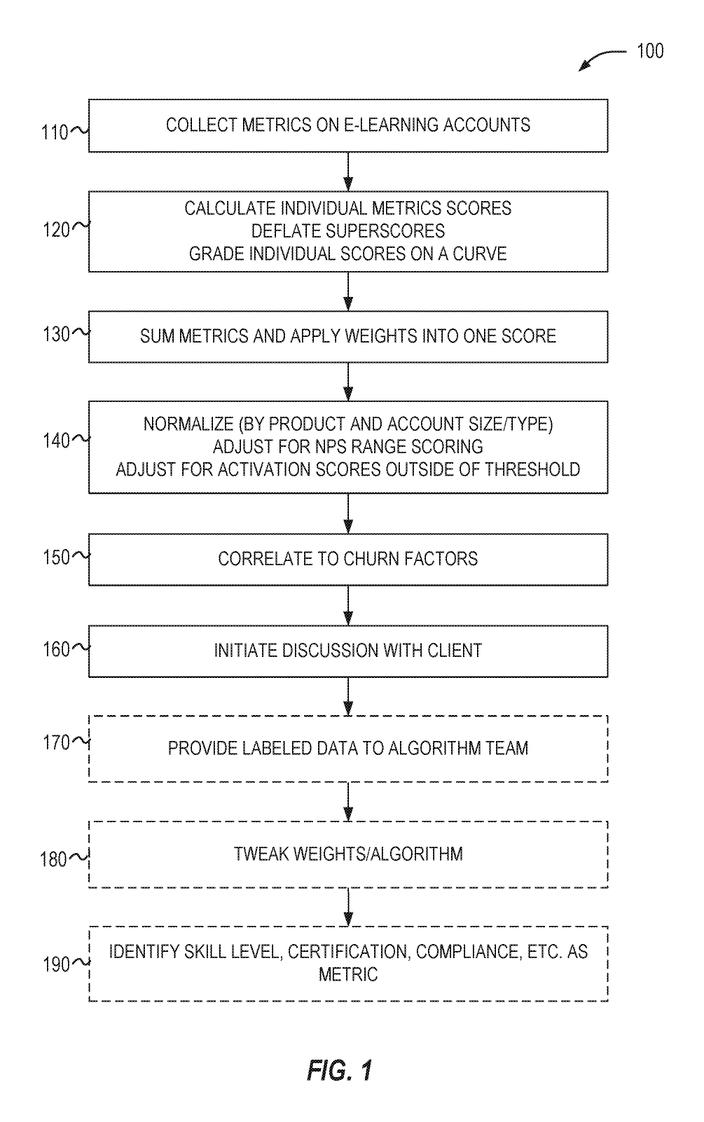

FIG. 1 is a flow diagram illustrating a method 100 for engagement scoring, according to an embodiment. An e-learning product may collect a variety of metrics during installation, launch and runtime. An e-learning product may be licensed or contracted from an e-learning provider to one or more clients, or customers. Each product may be geared toward a specific number of users, and/or provide tiered levels of service. A family of products such as may be provided by Lynda.com® from LinkedIn, for example, may include basic and premium level products. An e-learning platform or product may be geared toward higher education, government and/or corporate or enterprise training, and may have different subject modules or learning programs available to different products or based on client contracts.

In an example, metrics may be collected for an e-learning product in block 110. In an example, metrics may be directly collected by a module linked to the e-learning platform and forwarded to a collection process or stored in a database. In another example, metrics may be inherent in the operation of the product and stored as raw data, locally. A metrics collection engine may retrieve the raw metrics from the local database for further analysis. Metrics that may be collected for use in engagement scoring may include product and contract level for a client, number of seats purchased, number of activated seats, number of unique logins, number of logins per user, views per user, unique view rates, minutes viewed per user, subjects completed, skills achieved, etc. Metrics may be collected as a snapshot or for a specific period of time.

The individual metrics collected may have varying value as engagement scores or as indicators of success. In an embodiment, the individual scores are combined as scores which may be combined as weighted sums to result in a single engagement score. The raw metrics may be combined and calculated as various rates over a period of time to produce trend data, in block 120. For instance, an activation rate may be calculated as the ratio of activate seats to purchased seats. A unique login rate may be calculated as the ratio of distinct users with at least one login to the number of activated seats. Views per user rate may be calculated as the ratio of total videos (or training content) to activated seats. A unique viewer rate may be calculated as the ratio of distinct users with at least one view to the number of activated seats. The number of minutes used per user rate may be calculated as a ratio of number of minutes viewed to the number of activated seats. Using the number of activated seats as the denominator in the ratio calculation may be a better indicator of usage than purchased seats in the event that a client has purchased many more seats than necessary, for a given time period, for instance, planning for growth.

Once the base metrics and ratios are calculated, it may be useful to ensure that the numbers are not artificially inflated. For instance, a client may have purchased 100 seats, but actually be using 120 seats due to unforeseen growth. If there is a lag in changing the contracted seats, then the activation rate would appears as 120%. Thus, these inflated values may be adjusted downward, in block 120. The individual scores may then be graded on a curve as compared to other clients in the same class, e.g., for the same level product, and in the same industry, with about the same number of purchased or activated seats, etc. For instance, the individual scores may be divided by the highest score in metric category, so the account with the most usage in that metric category receives a score of 1. All other accounts in the category would receive a score of less than one for that individual metric.

Once adjusted for artificial superscoring (e.g., inflated numbers) and curve adjusted, the metrics may be combined into a weighted sum, or engagement score, in block 130.

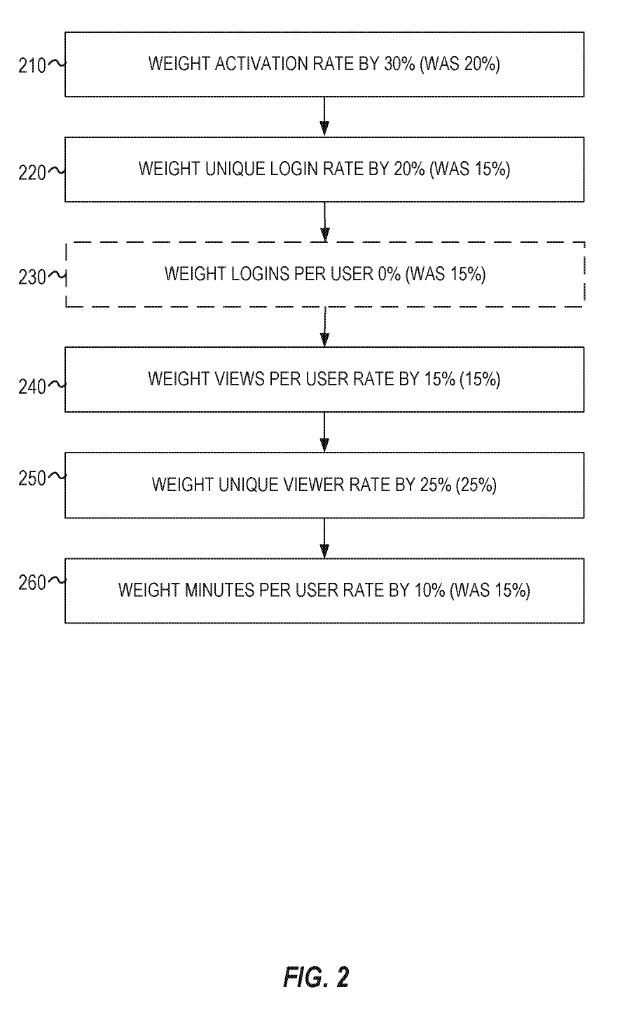

FIG. 2 is a flow diagram illustrating a weighting method, according to an embodiment. The authors have identified a useful formula for engagement scoring to identify potential churn. The term churn is used to indicate that a client plans to or actually discontinues use of the e-learning product. An e-learning provider, of course, wants to minimize churn of their products, and a client wants to receive value from the e-learning contract. No standardized formula exists in the prior art to provide an engagement score that can appropriately predict churn or trend to/from churn. A variety of factors have been investigated by the authors to provide a valuable single engagement score that is a good predictor for churn or success. In an embodiment, the activation rate may be weighted by 30% in block 210. The unique login rate may be weighted by 20% in block 220. The logins per user was initially investigated as included in the calculation, but abandoned for other viewer metrics. The weight for this metric may be increased and weighted in block 230, in the future. Views per user may be weighted as 15% in block 240. Unique views per user may be weighted as 25% in block 250. And minutes viewed per user rate may be weighted as 10% in block 260.

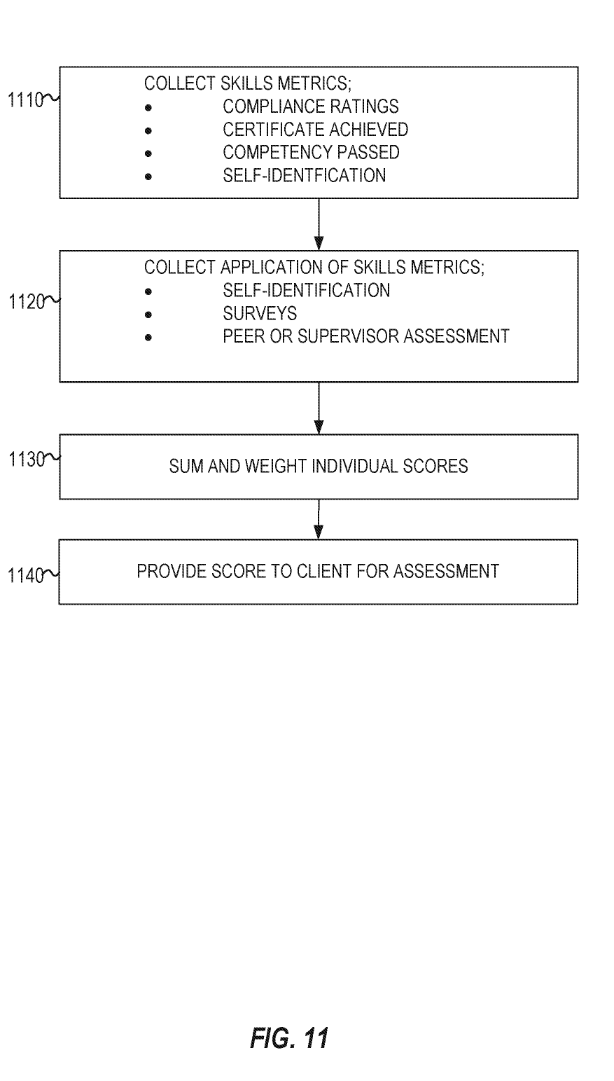

Initial weighting values other than those listed above were investigated and adjusted based on empirical study, to provide a useful measure for engagement scoring. For instance, minutes per user rate 260 was adjusted down to 10% from 15% after noting that different content or videos are of different length. For instance one learning module might be 30 minutes in length, and another 60 minutes in length. Thus, the weighting was reduced so as not to skew the data for lengthy content. In an example, a single user might view two 30 minute videos (e.g., two modules) and another user might view one module with a length of 60 minutes. If only time viewed were a factor, then the user who viewed two separate modules would be counted as less important, and yet that user was a return customer, so to speak. The weights and metrics may be adjusted for specific clients, contracts, or subject areas. For instance, future metrics may include skill acquired, which may include completion of a specific series of course material, and may include completion of exams or certification, to be discussed in more details with FIG. 11. The formula for engagement score may be adjusted to include metrics which may be easier to collect in the future, and customized for a specific product.

Referring again to FIG. 1, once the individual metrics have been weighted and summed, resulting in a preliminary score, the preliminary score may be normalized for product/account, in block 140. In an embodiment, the normalized score (z-score) may be calculated as

(total_score−avg(total_score)/stddev_samp(total_score),

where total_score is the initial preliminary score for a client account and product, avg(total_score) is the average of preliminary scores for similar clients using the product, over the same time period, and stddev_samp(total_score) is a function of the standard deviation of the total scores in the sample. It should be noted that the sample for averaging and standard deviations used for the normalization may be limited to similar products, similar sized accounts, for instance for seat activation rates, etc.

In an embodiment, the z-score may then be adjusted for Net Promoter Score (NPS) ranges. For instance, The NPS is an index ranging from −100 to 100 that measures the willingness of customers to recommend a company's products or services to others. It is used as a proxy for gauging the customer's overall satisfaction with a company's product or service and the customer's loyalty to the brand. Thus, the NPS index range may be a good indicator for engagement score comparison. In an example, the z-score for a client maybe divided by the maximum z-score in the sample so the account (e.g., client) with the highest engagement score receives a score of 100 and bottom account receives a −100 score. An engagement score may not meet the threshold for activation. In an example, the threshold for activation may be a minimum level of activation rate for which an account must pass to be acceptable. The thresholds may be set by a sales or other management teams. In an embodiment, a score that does not meet thresholds for activation may be revised to a 0, where a 0 is defined as an average score. Thus, negative scores are deemed below average (e.g., bad) and positive scores are deemed above average (e.g., good). Thresholds for activation may be based on a provider level service requirement and tenure (e.g., accounts in the first three months of their contract may have lower thresholds of activation to meet).

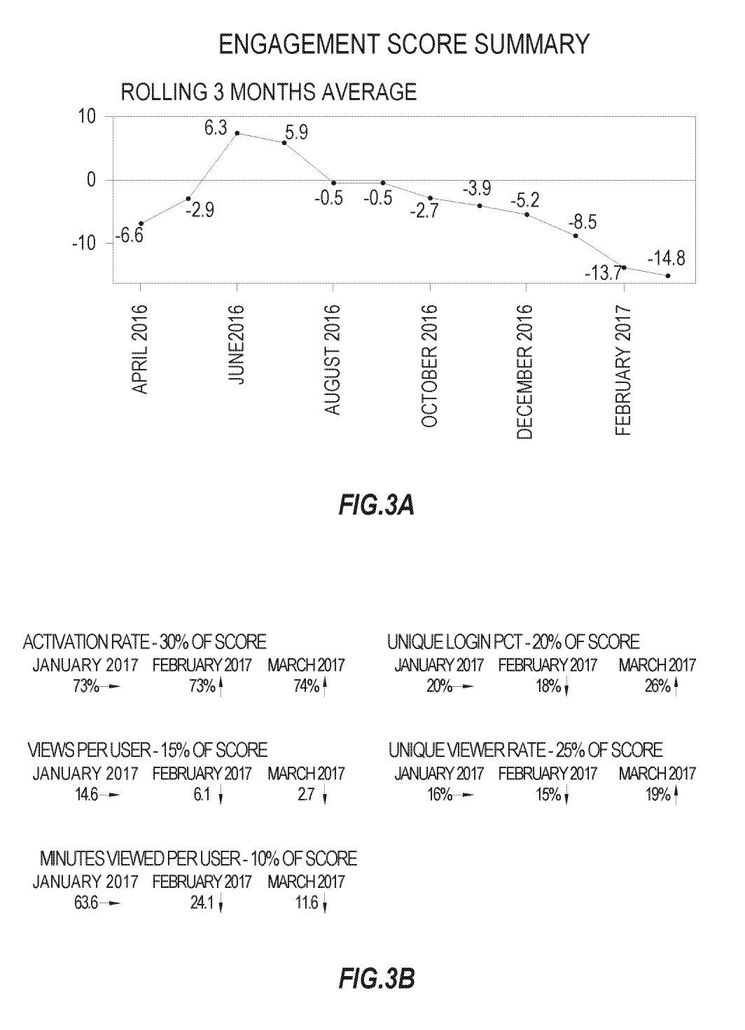

Once the engagement scores have been calculated and normalized, they may be reported internally (e.g., provider sales or customer service teams) and/or externally (e.g., client team). FIGS. 3A-3B illustrate a display of the engagement score and individual scores used in the weighted sum, for easy viewing. FIG. 3A illustrates a graph showing a rolling three month average of engagement scores, according to an embodiment. For example, a value for June is an average of April, May and June to smooth out potential extreme changes in scores from month to month. Also, it may take up to three months for new learning initiatives implemented by a client to take full effect. In this example, the engagement score for the client and product starts at a −6.6 and rises to a 6.3 before gradually declining over the 12 months to a −14.8. A provider account sales manager may easily see from the declining engagement score that this client may be on their way to cancelling the contract, or failing to renew. Referring again to FIG.1, a customer service agent or account sales manager (herein “provider user”) may easily visually inspect the trends in engagement score to assess the churn risk, in block 150. If a significant downward trend is identified, the provider user may visually inspect the factors that make up the engagement score. For instance, FIG. 3B illustrates a graphic showing trends in scoring metrics for the engagement scores in FIG. 3A, according to an embodiment. In this example, a rolling three month period may be easily viewed. As discussed above, the activation rate makes up 30% of the weighted sum and may be the first score to be viewed for analysis. In this example, it may be seen that activation score remained stable in January 2017 and increased in the following two months. However, the engagement score continued to decline over these three months, as shown in FIG. 3A (e.g., scores of −8.5, −13.7, −14.8). So the provider user may look to see which scores declined in that time period. In this example, it may be seen that both the views per user and minutes viewed per use both declined significantly for the three months under review. This quick visual review may trigger the provider user to take one or more actions to prevent churn by the client. Depending on which factor(s) are deemed to be affecting the engagement score the most in the time period, the provide user may perform additional training for the client, highlight specific course materials that may directly benefit the client, call a meeting of all client stakeholders who desire success of the e-learning program, etc.

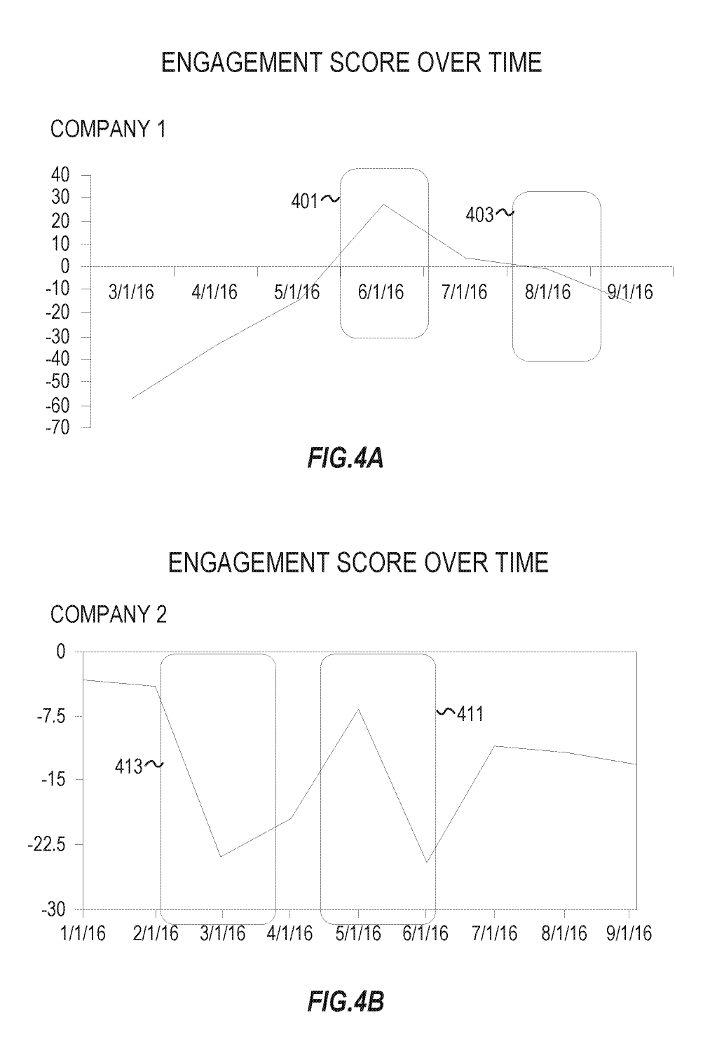

In an embodiment as discussed herein, the engagement scores are normalized over similar clients using the same product. Thus, it may be advantageous for the provider user to be able to make a quick comparison of engagement scores and metrics for multiple users as a comparison. FIG. 4A shows an engagement score over time for a first company, according to an embodiment, and FIG. 4B shows an engagement score over time for a second company, according to an embodiment. In an embodiment, an engagement score view may highlight areas when the engagement score is trending upwards 401, 411 and scores trending downward 403, 413. A provide user may have a calendar showing actions taken for the various clients and may easily see the effect the actions have on the score. The metrics scores may be viewed and compared, as well.

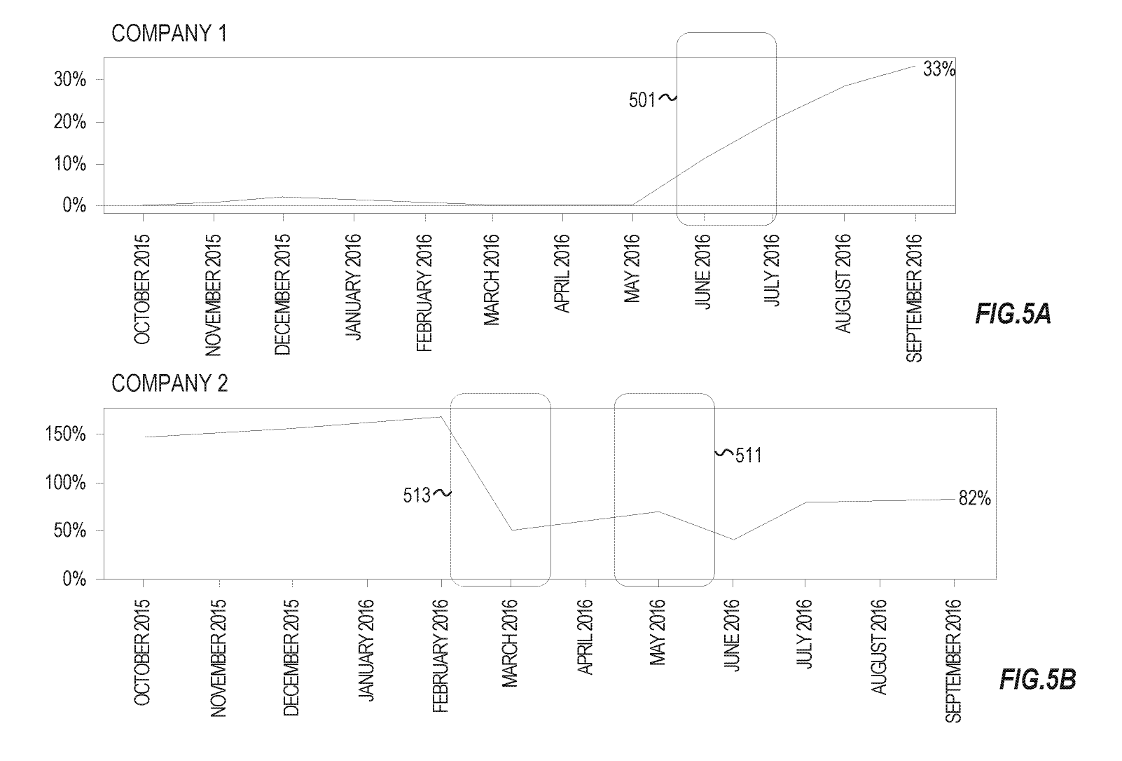

For instance, FIG. 5A shows an activation rate over time for a first company, according to an embodiment, and FIG. 5B shows an activation rate over time for a second company, according to an embodiment. Upward trends 501, 511 may be easily seen along with downward trends 513. While both companies showed upward and downward trends in their engagement scores (401, 411, 403, 413), it is easily seen that Company l does not have declining trends for activation rate. Thus, another metrics may be identified as primary factor for declining engagement scores.

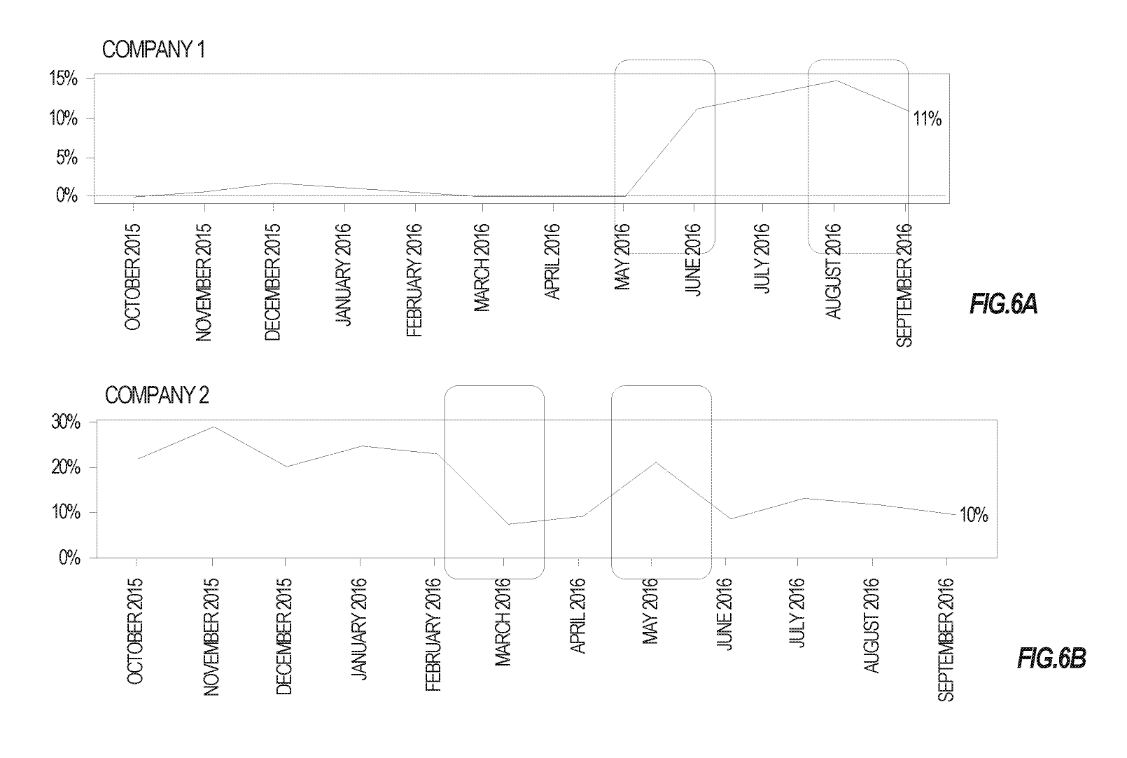

FIG. GA shows unique users logging in metric over time for a first company, according to an embodiment, and FIG. 6B shows users logging in metric over time for a second company, according to an embodiment. In this example, it may be seen that the metric for number of users logging in may more closely map the decline in engagement scores, by time period.

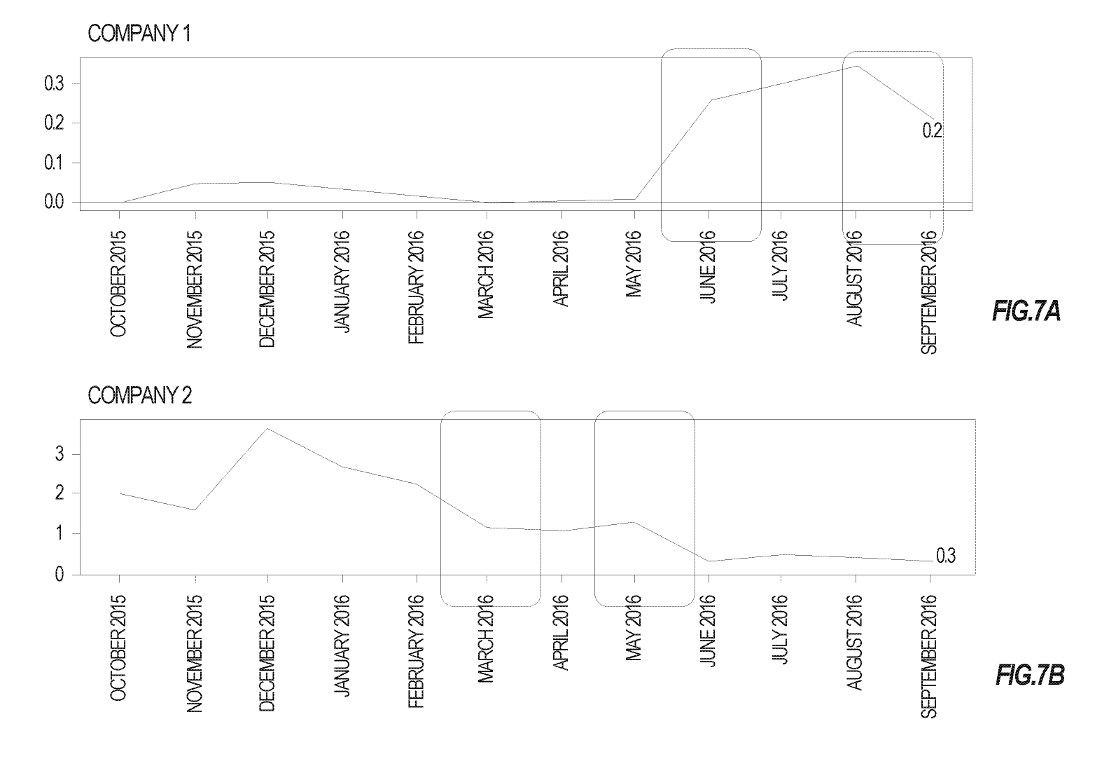

FIG. 7A shows logins per user metric over time for a first company, according to an embodiment, and FIG. 7B shows logins per user metric over time for a second company, according to an embodiment. It may be easily seen that the trend for number of logins per month closely tracks to the upward and downward movement in engagement score. It may also be seen that this metric may be redundant to, or cumulative with, other metrics. Therefore, in an embodiment, a redundant metric may not be included in the weighted engagement score. Some e-learning systems may easily provide metrics that are redundant to other metrics, in terms of applicability to the engagement score. In implementation, a score that is more easily collected may replace a hard to collect metric in the scoring algorithm, but result in an equivalent score. The display graphs may provide visual confirmation for which metrics may be redundant with others.

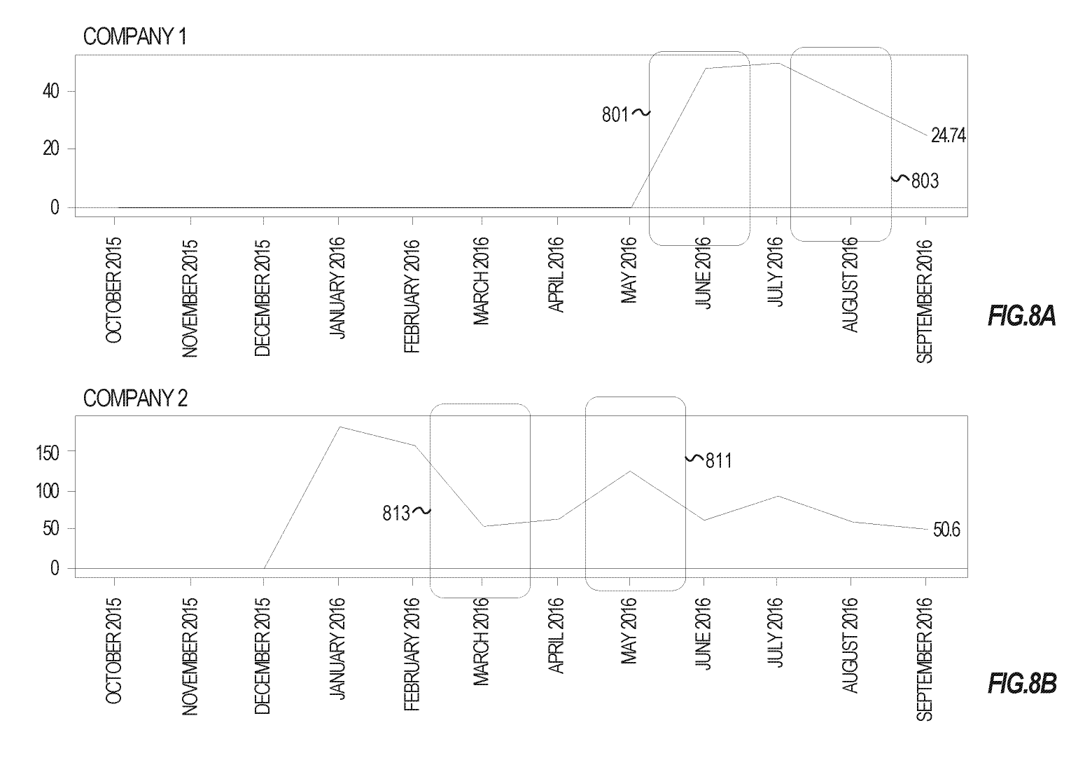

FIG. 8A shows minutes of content viewed per user metric over time for a first company, according to an embodiment, and FIG. 8B shows minutes of content viewed per user metric over time for a second company, according to an embodiment. It may be easily seen that the upward trends in this metric 801, 811 and downward trends 803, 813 also closely map to the upward and downward trends in engagement scores.

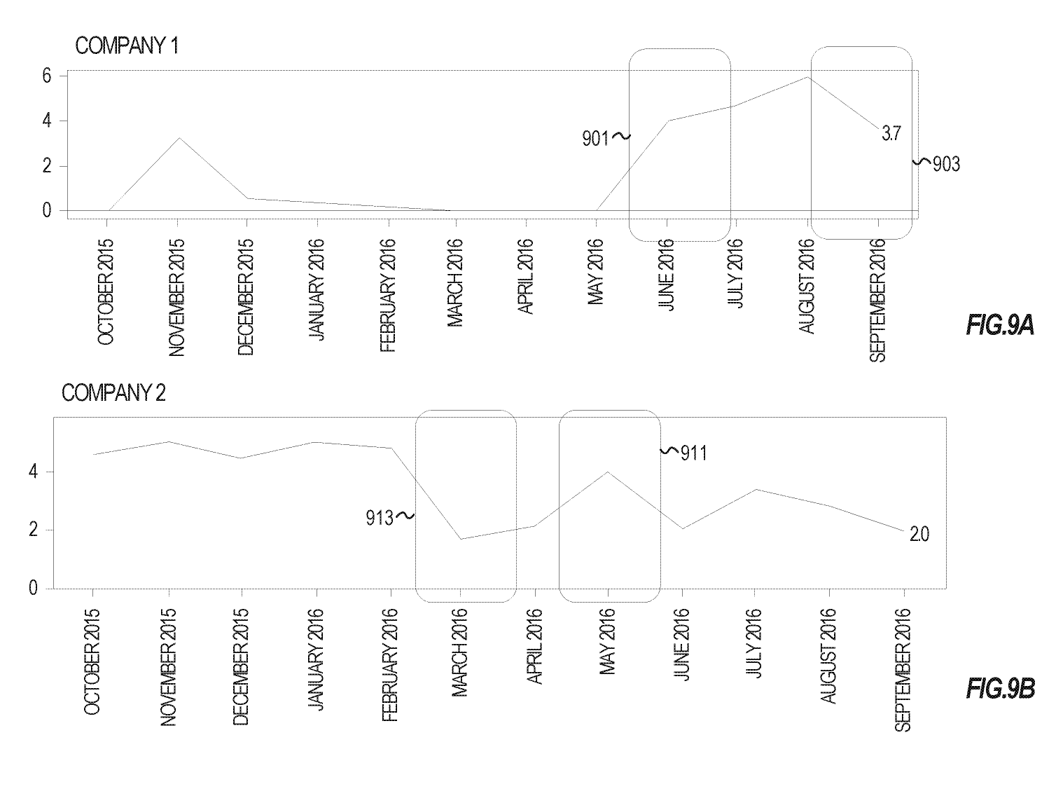

FIG. 9A shows monthly video views per user metric for a first company, according to an embodiment, and FIG. 9B shows monthly video views per user metric for a second company, according to an embodiment. Similarly, the upward and downward trends for this metric closely map to the upward and downward trends in engagement scores.

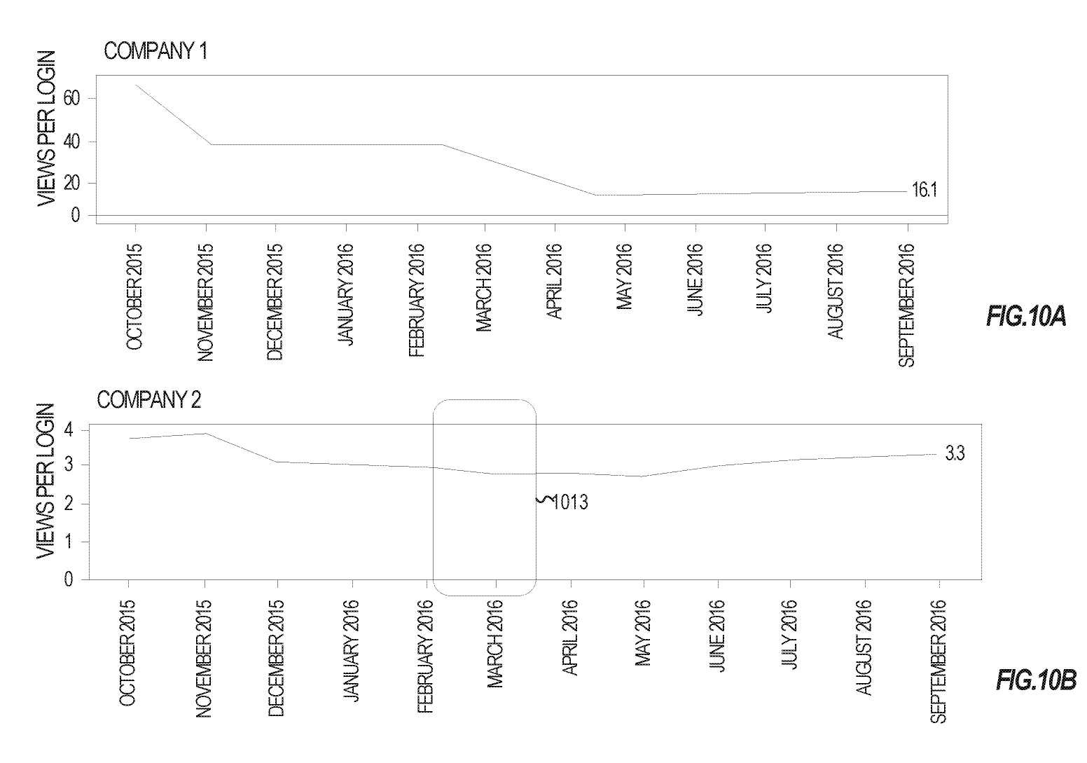

FIG. 10A shows views per login metric for a first company, according to an embodiment, and FIG. 10B shows views per login metric for a second company, according to an embodiment. In this example, the upward and downward trends are more subtle, such that only a downward trend 1013 for company 2 is highlighted in the graphic.

Referring again to FIG. 1, the provider user may easily look at the engagement score to identify possible churn. The individual metric trends may be viewed to determine an action based on a perception of which metrics are affecting the engagement score more adversely, in block 150. A client discussion may be the first action to be performed in block 160, to identify any specific concerns that the client may have.

In an embodiment, the provider users may wish to further refine the calculation for engagement score, perhaps as new metrics are able to be collected, and/or new insights are gained about the correlation of the individual metrics to the engagement score and churn potential. In this case, the analysts may provide labeled data or analysis of the churn correlations to an algorithm or sales team in block 170. The algorithm or sales team may determine after many months of data has been collected that logins per user trends are a good indicator of churn and increase the weight of this metric upwards from zero. Any decision on changing the metrics used or weights of the metrics may be applied to the process in block 180 for use in future engagement score calculations. In an embodiment, the trending data and correlation to the engagement score, as well as metrics that are not used in the weighting may be provided as inputs to a machine learning module for training. The model, over time, may make recommendations for changing the weighting, or perform the changes automatically. In an embodiment, the sales or algorithm team may override recommendations from the trained model.

In an embodiment, skill level metrics may be used in the engagement score metrics, or provide an additional scoring to identify skills improved or used based on engagement with the e-learning system, in block 190. Some skill metrics may be collected in future e-learning systems to identify the skill level of the user; identify skill certifications or compliance of the user, etc.

FIG. 11 is a flow diagram illustrating a method for scoring skills gained, according to an embodiment. In an embodiment, the engagement score is a valuable metric for the provider, allowing the provider to initiate actions to maintain customer engagement or satisfaction and avoiding churn. However, clients may have their own measurements of success for e-learning systems. In some industries, a level of competence or training compliance may be necessary for employees, for instance to maintain a professional certification or license. In some industries, continual improvement of skills and skill levels is crucial to employee satisfaction and retention. In existing systems, skill acquisition or improvement, and certification or compliance with continuing education is typically measured on an individual basis.

In an embodiment, metrics associated with skills gained and skill levels may be collected in block 1110. An e-learning system may group courses and viewing content together in sets or groups for an identified curriculum, similar to brick and mortar universities. Completion of a curriculum may set a completion flag, or other indicator, for individual users. Percent completed of a curriculum may be tracked, as well. Other metrics that may be collected include, but are not limited to, compliance ratings, certificate achieved, competency completed (e.g., for modules with testing), and self-identification of skills gained. These metrics may be collected and scored per set, per activation, per enrollment in a curriculum, etc. The various scoring may be customized for clients or groups of clients, or specific industries. For instance, in some jurisdictions, attorneys or other professionals are required to complete a number of continuing credits on an annual, hi-annual or tri-annual basis. Some e-learning products provide corporate wide training for a contract fee including a number of seats, rather than requiring individuals to pay for classes separately. Tracking metrics for completion of these credits may indicate whether the e-learning product is being sufficiently used by employees to provide a reasonable return on investment.

Some clients may place value on whether their employees are applying their acquired skills to their jobs. Application of skills may be a difficult metric to assess. Collection of a variety of metrics in this area may be performed in block 1120. Skill application metrics that may be collected include, but are not limited to, self-identification of application of a new skill, survey responses, peer or supervisor assessments, etc. In an embodiment, when a user completes a training course or curricula, the user may flag this skill as having been applied in their job by going back and checking a yes/no indicator for the skill. In an example, the skill applied indicator may default to no until changed by the user. In an example, a periodic electronic survey may be sent to users who have completed training for a skill asking for the yes/no response. Management of the survey may automatically update the indicators. In an example, a peer or supervisor may update the indicators for a user, for instance, during their annual review. Indicator updates may be initiated at more frequent intervals, as desired by the client.

A provider may group clients and industries together into metrics categories, and use different metrics collection procedures for the different categories of clients. Different score weights that may depend on the nature of the industry may be used, as well. By grouping clients, this way, a skills achieved score may be generated in similar procedure to the generation of the engagement score, in block 1130. For instance, by collecting similar metrics for multiple clients, the individual and final scores may be normalized over an industry for comparison. A client may measure its success in skill assessment using only individual metrics. However, as can be seen in the analysis of individual score metrics to engagement score, as discussed above, a single skills assessment score may be a valuable tool for a client to quickly assess the value of their e-learning contract. The skills assessment score may be provided to the client in block 1140. The provider sales manager should be aware of the clients' measure(s) for success, and may quickly assess success or possible churn by viewing the engagement score and/or the skills assessment score. In an embodiment, the engagement score and skills assessment score may be two individual measures. In an embodiment, the skills assessment metrics may be integrated in with the engagement score metrics and weighted as desired to result in a single overall score.

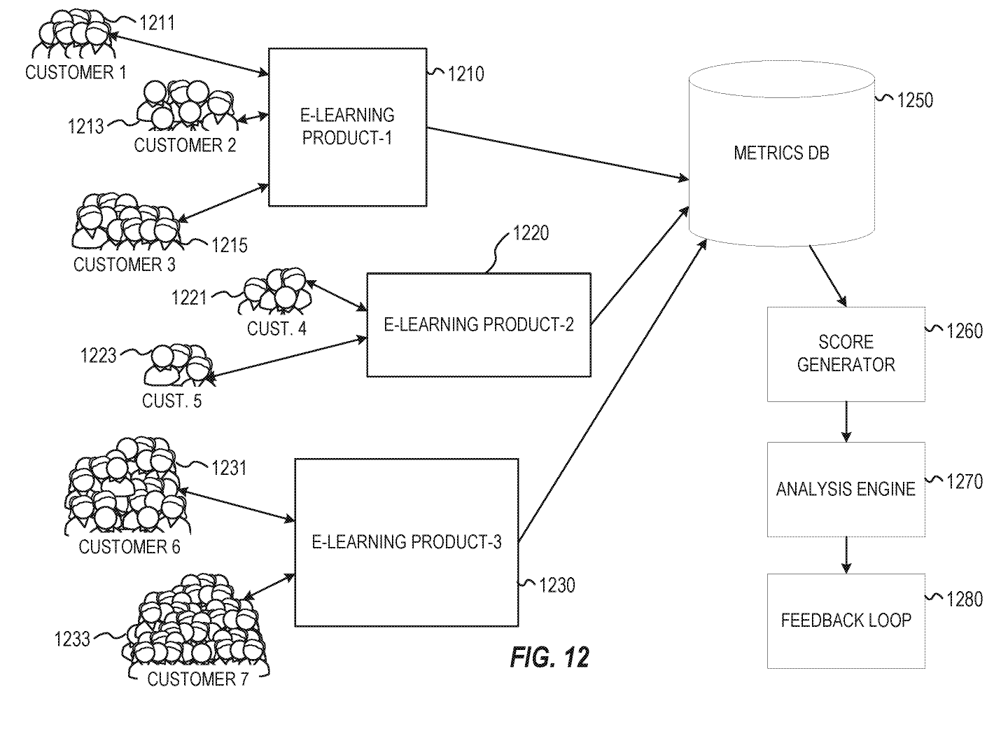

FIG. 12 is a system block diagram illustrating a metrics collection and score generating system, according to an embodiment. In an embodiment, multiple products may be available in an e-learning product family. In the example, three products are shown 1210, 1220, 1230. In an embodiment, products in a product family may be grouped together based on the contract size, for instance based on number of seats, or users. In an embodiment, product usage may be grouped together based on industry, or skill compliance/competency requirements. In this example Product-1 1210, as shown, is a product in the family for medium-sized clients 1211, 1213, 1215. In this example, Product-2 1220, as shown, is a product in the family for small-sized clients 1221, 1223. And in this example, Product-3 1230, as shown, is a product in the family for large-sized clients 1231, 1233.

In an embodiment, the individual score metric for products in the product family may be collected by the various e-learning platforms 1210, 1220, 1230 and stored in metrics database 1250. It should be understood that the various products may have individual metrics databases (not shown), and different metrics may be stored in different databases. A metrics database may be coupled to the e-learning platform either locally or via a network, and the network may be private or public. Metrics database 1250 is accessible to a score generator logic module, engine, or device 1260. In an embodiment, the score generator may be any hardware, software, or firmware device, or combination thereof, which serves to gather the collected metrics from the metrics database 1250 and generate a score according to the methods as described herein, especially in conjunction with FIGS. 1, 2, and 11. The generated score may be sent to, or retrieved by, an analysis engine 1270.

In an embodiment, the analysis engine 1270 may render and provide displays, such as depicted in FIGS. 3-10, for visual identification and confirmation of engagement or skills achieved scores, and other qualitative indicators of the success/failure of the e-learning products. In an embodiment, data analysts or provider users may view the displays and make a quick judgement call as to whether a corrective or preemptive action is required to avoid churn and/or improve customer satisfaction. In an embodiment, the engagement or other score may be compared to pre-defined threshold. An automatic notification may be sent to one of the client, provider user, or both to indicate the score. An explanation and/or recommended action may automatically be provided with the score.

In an embodiment, it may be desired to perform continuous improvement in the methods for calculating and analyzing the engagement and skills achievement scores. Once scores have been calculated for several time periods, a provider user may identify trends in either the individual scores or engagement/skills achievement scores, or both, and further identify correlations between and among the scores. A sales or customer service team may recommend a change in the weighting algorithm(s) based on empirical data and client feedback in a feedback loop process 1280. In an embodiment, the scores may be provided for additional training of a machine learning model to assess and adjust the weighting and scoring algorithms. New metrics may be identified and collected in the future and then be folded in to the scoring algorithms, as desired. For instance, as a non-limiting example, bandwidth or response times may become a factor in customer satisfaction. Existing systems may not be able to collect robust data for individuals, but future systems may be able to collect this data and store it in the metrics database 1250 for inclusion in the scoring. Similarly, existing systems may not be able accurately track viable skills gained or skills applied metrics. When future systems can accurately collect skills metrics for inclusion in the scoring, these skill metrics may be included in the scoring. In an embodiment, as new metrics are collected, they may be fed in to a machine learning module as variable parameters so that correlations may be learned. Once correlations are identified, either manually, or by a machine learning module, the scoring and weighting algorithms may be adjusted, accordingly, in the feedback loop process 1280.

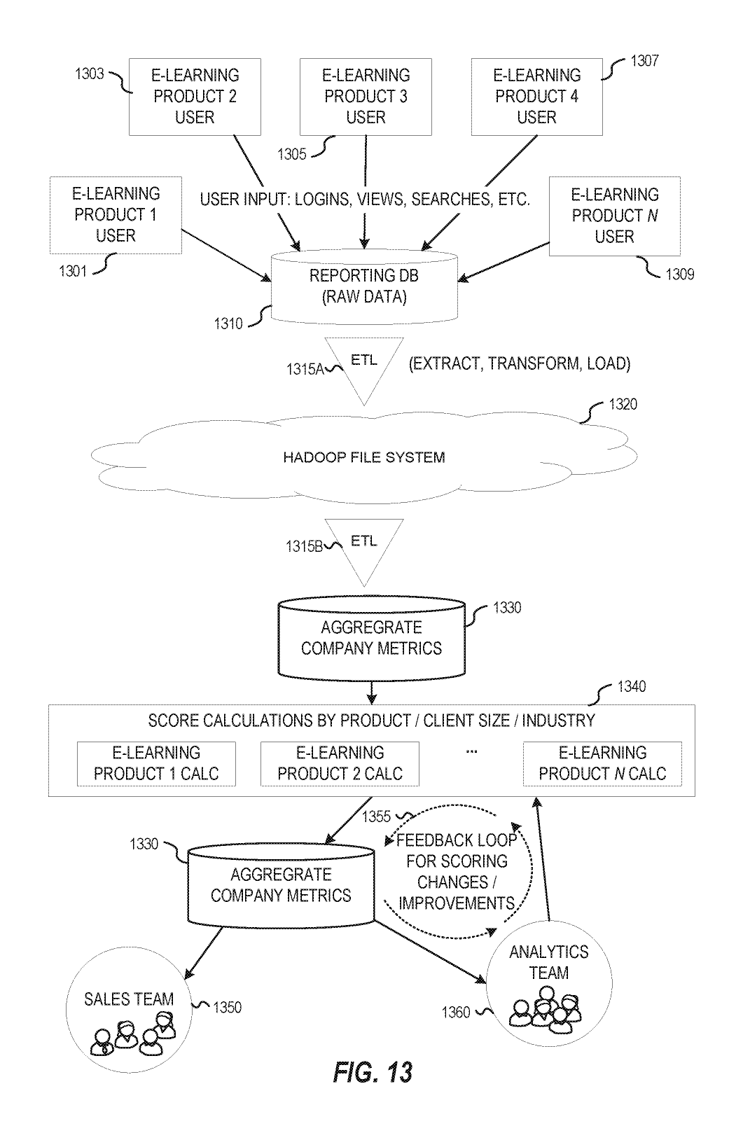

FIG. 13 is a system block diagram illustrating metrics collection and score generating system with feedback loop, according to an embodiment. In an example, an e-learning product family may have several product levels for a family. A user may operate an e-learning product appropriate to number of seats licensed, subject area, industry, etc. In this example, five e-learning product levels 1301, 1303, 1305, 1307, and 1309 are shown. As users operate the products, metrics may be collected, such as user input, logins, views, searches, time online, etc. The metrics may be stored as raw data in a data store 1310. The raw metrics data may be extracted and transformed via an ETL process (e.g., ETL, extract, transform, load 1315A). Depending on the number of users, frequency of use and other enterprise factors, the raw data may be quite voluminous. The metrics data may be forwarded to a cloud system consistent with large data sets, for later data mining. In an example, a HADOOP file system 1320 may be used. A HADOOP Distributed File System (HDFS) is designed to store very large data sets reliably, and to stream those data sets at high bandwidth to user applications. In a large cluster, thousands of servers may both host directly attached storage and execute user application tasks.

The metrics data may be retrieved via an ETL process 1315B to store metrics aggregated by company/enterprise in one or more data stores 1330. Once the data has been aggregated, a score generator 1340 may retrieve the metrics and perform scoring calculations, as described above. Scoring calculations may be performed for each e-learning product, individually, for each company/enterprise. The scores may be associated with the product and company and stored in the company metrics database 1330. Intermediate charts and engagement scores may be provided to, or retrieved by, a sales team 1350 for analysis and possible action.

A feedback loop for process and algorithm improvement 1355 may be implemented. In an embodiment, an analytics team 1360 may retrieve the engagement score and intermediate metrics for analysis. Correlations between and among the data may be quickly identified by the visual renderings of the graphs, as discussed above. The analytics team may choose to alter the weights or substitute easy to collect metrics for hard to collect metrics when the metrics correlate to the same general result. When the analytics team identifies algorithmic improvements or modification, they may update the scoring algorithms in the score generator 1340. This continuous process improvement cycle may prove valuable as new metrics are capable of being collected.

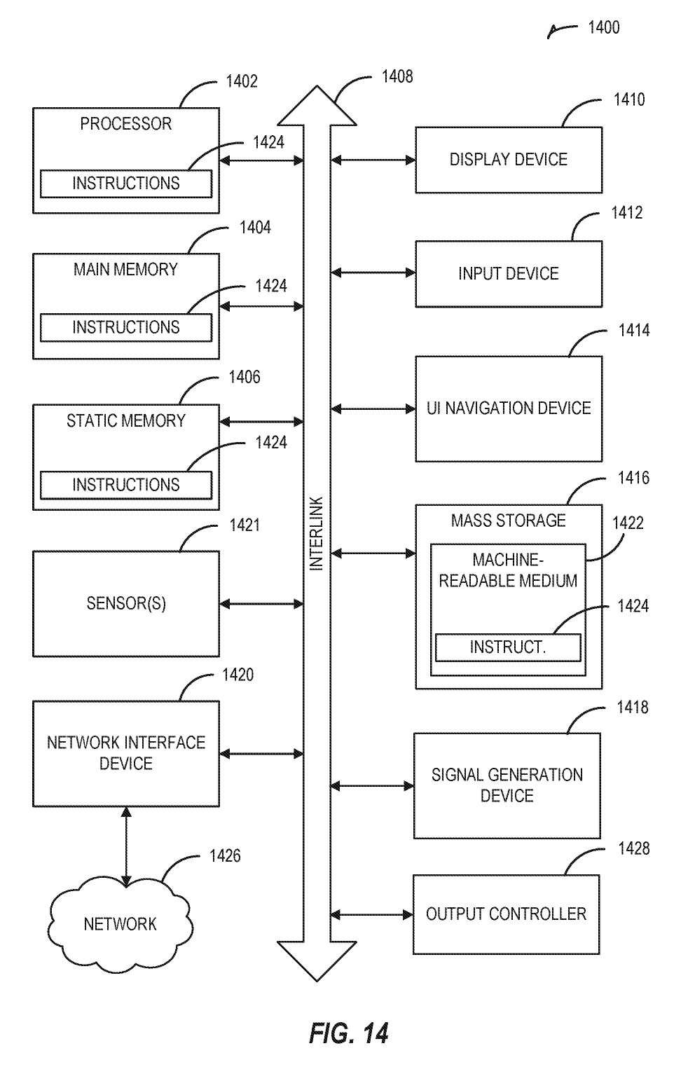

FIG. 14 illustrates a block diagram of an example machine 1400 upon which any one or more of the techniques (e.g., methodologies) discussed herein may perform. In alternative embodiments, the machine 1400 may operate as a standalone device or may be connected (e.g., networked) to other machines. In a networked deployment, the machine 1400 may operate in the capacity of a server machine, a client machine, or both in server-client network environments. In an example, the machine 1400 may act as a peer machine in peer-to-peer (P2P) (or other distributed) network environment. The machine 1400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 1400 may include a hardware processor 1402 (e.g., a central processing unit (CPU), a graphics processing unit (GPU), a hardware processor core, or any combination thereof), a main memory 1404 and a static memory 1406, some or all of which may communicate with each other via an interlink (e.g., bus) 1408. The machine 1400 may further include a display unit 1410, an alphanumeric input device 1412 (e.g., a keyboard), and a user interface (UI) navigation device 1414 (e.g., a mouse). In an example, the display unit 1410, input device 1412 and UI navigation device 1414 may be a touch screen display. The machine 1400 may additionally include a storage device (e.g., drive unit) 1416, a signal generation device 1418 (e.g., a speaker), a network interface device 1420, and one or more sensors 1421, such as a global positioning system (GPS) sensor, compass, accelerometer, or other sensor. The machine 1400 may include an output controller 1428, such as a serial (e.g., universal serial bus (USB), parallel, or other wired or wireless (e.g., infrared (IR), near field communication (NEC), etc.) connection to communicate or control one or more peripheral devices (e.g., a printer, card reader, etc.).

The storage device 1416 may include a machine readable medium 1422 on which is stored one or more sets of data structures or instructions 1424 (e.g., software) embodying or utilized by any one or more of the techniques or functions described herein. The instructions 1424 may also reside, completely or at least partially, within the main memory 1404, within static memory 1406, or within the hardware processor 1402 during execution thereof by the machine 1400. In an example, one or any combination of the hardware processor 1402, the main memory 1404, the static memory 1406, or the storage device 1416 may constitute machine readable media.

While the machine readable medium 1422 is illustrated as a single medium, the term “machine readable medium” may include a single medium or multiple media (e.g., a centralized or distributed database, and/or associated caches and servers) configured to store the one or more instructions 1424.

The term “machine readable medium” may include any medium that is capable of storing, encoding, or carrying instructions for execution by the machine 1400 and that cause the machine 1400 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1424 may further be transmitted or received over a communications network 1426 using a transmission medium via the network interface device 1420 utilizing any one of a number of transfer protocols (e.g., frame relay, internet protocol (IP), transmission control protocol (TCP), user datagram protocol (LTDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1420 may include one or more physical jacks (e.g., Ethernet, coaxial, or phone jacks) or one or more antennas to connect to the communications network 1426. In an example, the network interface device 1420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1400, and includes digital or analog communications signals or other intangible medium to facilitate communication of such software.

### ADDITIONAL NOTES AND EXAMPLES

Examples may include subject matter such as a method, means for performing acts of the method, at least one machine-readable medium including instructions that, when performed by a machine cause the machine to performs acts of the method, or of an apparatus or system for engagement scoring for e-learning systems, according to embodiments and examples described herein.

Example 1 is a system for engagement scoring, comprising: a processor communicatively coupled with a metrics database, and memory having instructions to perform scoring logic configured to generate a single engagement score from individual metrics scores retrieved from the metrics database, the scoring logic when executed on the processor causes the processor to: retrieve metrics associated with usage of an electronic learning (e-learning) product from the metrics database; calculate individual metrics scores for a time period and for a set of users associated with the e-learning product and an account; adjust the individual metrics scores according to a curve relative to scores collected for one or more additional sets of users; generate a weighted sum of the adjusted individual metrics scores into a single score; normalize the single score with one or more additional single scores associated with the one or more additional sets of users, the normalizing by product and account; adjust the normalized single score into a pre-defined range to generate a final single engagement score; and provide the final single engagement score to a user to identify engagement of the e-learning product by the set of users.

In Example 2, the subject matter of Example 1 optionally includes wherein when the final single engagement score falls below a pre-defined threshold, the final single engagement score indicates dissatisfaction by the set of users, and wherein when the final single engagement score indicates dissatisfaction by the set of users, triggering an action by a provider of the e-learning product to improve satisfaction levels of the set of users.

In Example 3, the subject matter of any one or more of Examples 1-2 optionally include wherein the final single engagement score includes skills assessment score metrics, and wherein when the skills assessment score metrics are a qualitative measure of skills attained or skills applied by the set of users, wherein the skills attained and the skills applied are related to skill training modules of the e-learning product.

In Example 4, the subject matter of any one or more of Examples 1-3 optionally include an analysis engine configured to correlate the calculated individual metrics scores with trends in the final single engagement score; and a feedback loop module configured to adjust algorithmic components of the weighted sum generation based at least on the correlation of the calculated individual metrics scores with trends in the final single engagement score.

Example 5 is a computer implemented method, comprising: retrieving metrics associated with usage of an electronic learning (e-learning) product from a metrics database; calculating individual metrics scores for a time period and for a set of users associated with the e-learning product and an account; adjusting the individual metrics scores according to a curve relative to scores collected for one or more additional sets of users; generating a weighted sum of the adjusted individual metrics scores into a single score; normalizing the single score with one or more additional single scores associated with the one or more additional sets of users, the normalizing by product and account; adjusting the normalized single score into a pre-defined range to generate a final single score; and providing the final single score to a user to identify a use assessment of the e-learning product by the set of users.

In Example 6, the subject matter of Example 5 optionally includes wherein the final single score is an engagement score, and wherein when the engagement score falls below a pre-defined threshold, the engagement score indicates dissatisfaction by the set of users, and wherein when the engagement score indicates dissatisfaction by the set of users, triggering an action by a provider of the e-learning product to improve satisfaction levels of the set of users.

In Example 7, the subject matter of any one or more of Examples 5-6 optionally include wherein the final single score is an skills assessment score, and wherein the skills assessment score is a qualitative measure of skills attained or skills applied by the set of users, wherein the skills attained and the skills applied are related to skill training modules of the e-learning product.

In Example 8, the subject matter of Example 7 optionally includes wherein the individual metrics scores include at least one of: user compliance ratings, user certificate achieved, user competency passed, user skill self-identification_{;} and identification of application of skills.

In Example 9, the subject matter of any one or more of Examples 5-8 optionally include wherein the weighted sum of the adjusted individual metrics scores includes weighting metrics at least associated with activation rate, login rate, views per user rate, unique viewer rate or minutes used per user rate.

In Example 10, the subject matter of any one or more of Examples 5-9 optionally include initiating corrective action with an account owner associated with the set of users, the corrective action designed to avoid account cancelation or failure to renew, due to low satisfaction with the e-learning product as indicated by the final single score.

In Example 11, the subject matter of any one or more of Examples 5-10 optionally include providing the calculated individual metrics scores and the final single score to an analysis engine; analyzing the calculated individual metrics scores with respect to the final single score to identify correlation in the calculated individual metrics scores with trends in the final single score; and adjusting algorithmic components of the weighted sum generation based at least on the correlation in the calculated individual metrics scores with trends in the final single score.

In Example 12, the subject matter of Example 11 optionally includes wherein the analyzing and adjusting are performed by a machine learning module communicatively coupled to the metrics database, wherein the machine learning module is retrained with metrics data from the metrics database, and the adjusted individual metrics scores, and the final single score.

Example 13 is a computer readable storage medium having instructions stored thereon, the instructions when executed on a machine cause the machine to: retrieve metrics associated with usage of an electronic learning (e-learning) product from a metrics database; calculate individual metrics scores for a time period and for a set of users associated with the e-learning product and an account; adjust the individual metrics scores according to a curve relative to scores collected for one or more additional sets of users; generate a weighted sum of the adjusted individual metrics scores into a single score; normalize the single score with one or more additional single scores associated with the one or more additional sets of users, the normalizing by product and account; adjust the normalized single score into a pre-defined range to generate a final single score; and provide the final single score to a user to identify satisfaction of the e-learning product by the set of users.

In Example 14, the subject matter of Example 13 optionally includes wherein the final single score is an engagement score, and wherein when the engagement score falls below a pre-defined threshold, the engagement score indicates dissatisfaction by the set of users.

In Example 15, the subject matter of Example 14 optionally includes instructions to trigger an action by a provider of the e-learning product to improve satisfaction levels of the set of users when the engagement score indicates dissatisfaction by the set of users.

In Example 16, the subject matter of any one or more of Examples 13-15 optionally include wherein the final single score is an skills assessment score, and wherein the skills assessment score is a qualitative measure of skills attained or skills applied by the set of users, wherein the skills attained and the skills applied are related to skill training modules of the e-learning product.

In Example 17, the subject matter of Example 16 optionally includes wherein the individual metrics scores include at least one of: user compliance ratings, user certificate achieved, user competency passed, user skill self-identification, and identification of application of skills.

In Example 18, the subject matter of any one or more of Examples 13-17 optionally include wherein the weighted sum of the adjusted individual metrics scores includes weighting metrics at least associated with activation rate, login rate, views per user rate, unique viewer rate or minutes used per user rate.

In Example 19, the subject matter of any one or more of Examples 13-18 optionally include instructions to: initiate corrective action with an account owner associated with the set of users, the corrective action designed to avoid account cancelation or failure to renew, due to low satisfaction with the e-learning product as indicated by the final single score.

In Example 20, the subject matter of any one or more of Examples 13-19 optionally include instructions to: provide the calculated individual metrics scores and the final single score to an analysis engine; analyze the calculated individual metrics scores with respect to the final single score to identify correlation in the calculated individual metrics scores with trends in the final single score; and adjust algorithmic components of the weighted sum generation based at least on the correlation in the calculated individual metrics scores with trends in the final single score.

In Example 21, the subject matter of Example 20 optionally includes wherein the instructions to analyze and adjust are performed by a machine learning module communicatively coupled to the metrics database, wherein the machine learning module is retrained with metrics data from the metrics database, and the adjusted individual metrics scores, and the final single score.

Example 22 is a system configured to perform operations of any one or more of Examples 1-21.

Example 23 is a method for performing operations of any one or more of Examples 1-21.

Example 24 is a machine readable storage medium including instructions that, when executed by a machine cause the machine to perform the operations of any one or more of Examples 1-21.

Example 25 is a system comprising means for performing the operations of any one or more of Examples 1-21.

The techniques described herein are not limited to any particular hardware or software configuration; they may find applicability in any computing, consumer electronics, or processing environment. The techniques may be implemented in hardware, software, firmware or a combination, resulting in logic or circuitry which supports execution or performance of embodiments described herein.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural, declarative, and/or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product, also described as a computer or machine accessible or readable medium that may include one or more machine accessible storage media having stored thereon instructions that may be used to program a. processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may he used in a compressed or encrypted format.

Program code may be implemented in programs executing on programmable machines such as mobile or stationary computers, personal digital assistants, smart phones, mobile Internet devices, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments, cloud environments, peer-to-peer or networked microservices, where tasks or portions thereof may be performed by remote processing devices that are linked through a communications network.

A processor subsystem may be used to execute the instruction on the machine-readable or machine accessible media. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

Examples, as described herein, may include, or may operate on, circuitry, logic or a number of components, modules, or mechanisms. Modules may be hardware, software, or firmware communicatively coupled to one or more processors in order to carry out the operations described herein. It will be understood that the modules or logic may be implemented in a hardware component or device, software or firmware running on one or more processors, or a combination. The modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures. As such, modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured, arranged or adapted by using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

While this subject matter has been described with reference to illustrative embodiments, this description is not intended to be construed in a limiting or restrictive sense. For example, the above-described examples (or one or more aspects thereof) may be used in combination with others. Other embodiments may be used, such as will be understood by one of ordinary skill in the art upon reviewing the disclosure herein. The Abstract is to allow the reader to quickly discover the nature of the technical disclosure. However, the Abstract is submitted with the understanding that it will not be used to interpret or limit the scope or meaning of the claims.

What is claimed is:

1. A system for engagement scoring, comprising:
a processor communicatively coupled with a metrics database, and memory having instructions to perform scoring logic configured to generate a single engagement score from individual metrics scores retrieved from the metrics database, the scoring logic when executed on the processor causes the processor to:
retrieve metrics associated with usage of an electronic learning (e-learning) product from the metrics database;
calculate individual metrics scores for a time period and for a set of users associated with the e-learning product and an account;
adjust the individual metrics scores according to a curve relative to scores collected for one or more additional sets of users;
generate a weighted sum of the adjusted individual metrics scores into a single score;
normalize the single score with one or more additional single scores associated with the one or more additional sets of users, the normalizing by product and account;
adjust the normalized single score into a pre-defined range to generate a final single engagement score; and
provide the final single engagement score to a user to identify engagement of the e-learning product by the set of users.

2. The system as recited in claim 1, wherein when the final single engagement score falls below a pre-defined threshold, the final single engagement score indicates dissatisfaction by the set of users, and wherein when the final single engagement score indicates dissatisfaction by the set of users, triggering an action by a provider of the e-learning product to improve satisfaction levels of the set of users.

3. The system as recited in claim 1, wherein the final single engagement score includes skills assessment score metrics, and wherein when the skills assessment score metrics are a qualitative measure of skills attained or skills applied by the set of users, wherein the skills attained and the skills applied are related to skill training modules of the e-learning product.

4. The system as recited in claim 1, further comprising:
an analysis engine configured to correlate the calculated individual metrics scores with trends in the final single engagement score; and
a feedback loop module configured to adjust algorithmic components of the weighted sum generation based at least on the correlation of the calculated individual metrics scores with trends in the final single engagement score.

5. A computer implemented method, comprising:
retrieving metrics associated with usage of an electronic learning (e-learning) product from a metrics database;
calculating individual metrics scores for a time period and for a set of users associated with the e-learning product and an account;
adjusting the individual metrics scores according to a curve relative to scores collected for one or more additional sets of users;
generating a weighted sum of the adjusted individual metrics scores into a single score;
normalizing the single score with one or more additional single scores associated with the one or more additional sets of users, the normalizing by product and account;
adjusting the normalized single score into a pre-defined range to generate a final single score; and
providing the final single score to a user to identify a use assessment of the e-learning product by the set of users.

6. The computer implemented method as recited in claim 5, wherein the final single score is an engagement score, and wherein when the engagement score falls below a pre-defined threshold, the engagement score indicates dissatisfaction by the set of users, and wherein when the engagement score indicates dissatisfaction by the set of users, triggering an action by a provider of the e-learning product to improve satisfaction levels of the set of users.

7. The computer implemented method as recited in claim 5, wherein the final single score is an skills assessment score, and wherein the skills assessment score is a qualitative measure of skills attained or skills applied by the set of users, wherein the skills attained and the skills applied are related to skill training modules of the e-learning product.

8. The computer implemented method as recited in claim 5, wherein the weighted sum of the adjusted individual metrics scores includes weighting metrics at least associated with activation rate, login rate, views per user rate, unique viewer rate or minutes used per user rate.

9. The computer implemented method as recited in claim 5, further comprising:
initiating corrective action with an account owner associated with the set of users, the corrective action designed to avoid account cancelation or failure to renew, due to low satisfaction with the e-learning product as indicated by the final single score.

10. The computer implemented method as recited in claim 5, further comprising:
providing the calculated individual metrics scores and the final single score to an analysis engine;
analyzing the calculated individual metrics scores with respect to the final single score to identify correlation in the calculated individual metrics scores with trends in the final single score; and
adjusting algorithmic components of the weighted sum generation based at least on the correlation in the calculated individual metrics scores with trends in the final single score.

11. The computer implemented method as recited in claim 10, wherein the analyzing and adjusting are performed by a machine learning module communicatively coupled to the metrics database, wherein the machine learning module is retrained with metrics data from the metrics database, and the adjusted individual metrics scores, and the final single score.

12. A computer readable storage medium having instructions stored thereon, the instructions when executed on a machine cause the machine to:
retrieve metrics associated with usage of an electronic learning (e-learning) product from a metrics database;
calculate individual metrics scores for a time period and for a set of users associated with the e-learning product and an account;
adjust the individual metrics scores according to a curve relative to scores collected for one or more additional sets of users;
generate a weighted sum of the adjusted individual metrics scores into a single score;
normalize the single score with one or more additional single scores associated with the one or more additional sets of users, the normalizing by product and account;
adjust the normalized single score into a pre-defined range to generate a final single score; and
provide the final single score to a user to identify satisfaction of the e-learning product by the set of users.

13. The computer readable storage medium as recited in claim 12, wherein the final single score is an engagement score, and wherein when the engagement score falls below a pre-defined threshold, the engagement score indicates dissatisfaction by the set of users.

14. The computer readable storage medium as recited in claim 13, further comprising instructions to trigger an action by a provider of the e-learning product to improve satisfaction levels of the set of users when the engagement score indicates dissatisfaction by the set of users.

15. The computer readable storage medium as recited in claim 12, wherein the final single score is an skills assessment score, and wherein the skills assessment score is a qualitative measure of skills attained or skills applied by the set of users, wherein the skills attained and the skills applied are related to skill training modules of the e-learning product.

16. The computer readable storage medium as recited in claim 15, wherein the individual metrics scores include at least one of:
user compliance ratings,
user certificate achieved,
user competency passed,
user skill self-identification, and
identification of application of skills.

17. The computer readable storage medium recited in claim 12, wherein the weighted sum of the adjusted individual metrics scores includes weighting metrics at least associated with activation rate, login rate, views per user rate, unique viewer rate or minutes used per user rate.

18. The computer readable storage medium as recited in claim 12, further comprising instructions to:
initiate corrective action with an account owner associated with the set of users, the corrective action designed to avoid account cancelation or failure to renew, due to low satisfaction with the e-learning product as indicated by the final single score.

19. The computer readable storage medium as recited in claim 12, further comprising instructions to:
provide the calculated individual metrics scores and the final single score to an analysis engine;
analyze the calculated individual metrics scores with respect to the final single score to identify correlation in the calculated individual metrics scores with trends in the final single score; and
adjust algorithmic components of the weighted sum generation based at least on the correlation in the calculated individual metrics scores with trends in the final single score.

20. The computer readable storage medium as recited in claim 19, wherein the instructions to analyze and adjust are performed by a machine learning module communicatively coupled to the metrics database, wherein the machine learning module is retrained with metrics data from the metrics database, and the adjusted individual metrics scores, and the final single score.
